(19) United States
(12) Patent Application Publication
(10) Pub. No.: US 2007/0263583 A1
(43) Pub. Date: Nov. 15, 2007

(54) Apparatus and method for allocating channel using auction algorithm in wireless communication system

(75) Inventors: Tae-In Hyon, Hwaseong-si (KR); Hoon Kim, Seoul (KR); Dae-Young Park, Suwon-si (KR); Sang-Boh Yun, Seongnam-si (KR); Sang-Wook Han, Daejeon (KR); Youngnam Han, Daejeon (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/801,558

(22) Filed: May 10, 2007

(30) Foreign Application Priority Data
May 12, 2006 (KR) 2006-0042723

(51) Int. Cl. H04Q 7/24

(52) U.S. Cl. 370/338

(57) ABSTRACT

An apparatus and method for allocating a channel using an auction algorithm in a wireless communication system. The method includes measuring a data rate of each channel; selecting one of the channels, when information on the channels is received from a base station, using the received information on the channels and the measured data rate; and determining a bidding price of the selected channel. Performance of the entire system can be improved by reducing complexity as well as guaranteeing an optimal value in the channel allocation.

### PRIORITY

This application claims priority under 35 U.S.C. § 119 to an application entitled “APPARATUS AND METHOD FOR ALLOCATING CHANNEL USING AUCTION ALGORITHM IN WIRELESS COMMUNICATION SYSTEM” filed in the Korean Intellectual Property Office on May 12, 2006 and allocated Serial No. 2006-42723, the contents of which are incorporated herein by reference.

### BACKGROUND OF THE INVENTION

1. Field of the Invention

The present invention relates to a wireless communication system, and more particularly, to an apparatus and method for allocating a channel using an auction algorithm in a wireless communication system.

2. Description of the Related Art

A Cognitive Radio (hereinafter, referred to as a CR) technology typically refers to a technology for determining wireless transmission parameters (such as a frequency, a modulation method, and an output power by recognizing circumferential environments) and automatically tracking unoccupied frequency bands according to time and location to achieve a desired communication as well as protect neighboring authenticated radio stations. In other words, the CR technology supports the flexible use of frequency bands for allowing a particular service to temporarily borrow an unoccupied frequency band. Therefore, the CR technology is a technology capable of increasing efficiency of frequency resources in a mobile communication environment.

In the CR system, an important issue is negotiation with users for use of unoccupied spectrum in association with spectrum allocation among CR users (e.g., mobile stations) as well as among CR base stations. Negotiation allows users to select a channel capable of guaranteeing an optimal data rate from unoccupied channels. Accordingly, a channel allocation method for allowing a plurality of users to obtain their desired frequencies in an efficient manner, is desired.

A channel allocation method for allocating two channels to two users will be discussed below. For the sake of clarity, it is assumed that there are two users (i.e., a first and second users) and two unoccupied channels (i.e., channels 1 and 2) in the system, where only a single channel can be allocated to a user. In addition, it is assumed that the first user (i.e., user 1) can obtain data rates of 10 Mbps and 9 Mbps from channels 1 and 2, respectively, and the second user (i.e., user 2) can obtain data rates of 8 Mbps and 4 Mbps from channels 1 and 2, respectively.

It is recognized that both the users 1 and 2 can obtain the highest data rate when the channel 1 is selected. In this case, the CR system may allocate the channel 1 to the user 1 who can obtain a data rate of 10 Mbps and the remaining channel 2 to the remaining user 2 according to a predetermined algorithm. This channel allocation method may be implemented by a Max-delete algorithm, in which a maximum value is detected from an M×M matrix (where 1 is an integer), a column and a row corresponding to the detected value are sequentially deleted, and another maximum value is detected from the remaining values, thereby searching for an object function value close to an optimal value, i.e., a sub-optimal value.

However, from the viewpoint of the entire communication system, a system gain (i.e., 9+8=17 Mbps) obtained by allocating the channels 2 and 1 to the users 1 and 2, respectively, is higher than a system gain (i.e., 10+4=14 Mbps) obtained by allocating the channels 1 and 2 to the users 1 and 2, respectively. Therefore, the system may allocate the channels 1 and 2 to the users 2 and 1, respectively, according to a predetermined algorithm. An algorithm which provides a representative channel allocation method for guaranteeing such an optimal value is known as the Hungarian algorithm. However, the Hungarian algorithm calculates the optimal value obtained by considering all the information on the matrix values in a centralized manner, and is therefore very complex.

On the other hand, an auction algorithm is known as a distributive algorithm capable of obtaining an optimal system gain using only local information of users by comparing throughputs of the best optimal channel and the next optimal channel and allocating the corresponding channel to a user having the highest difference between the throughputs of the channels. The Auction Algorithm is therefore more efficient than the Hungarian Algorithm.

Therefore, it would be possible to reduce the complexity as well as guarantee an optimal value if the channels are allocated in consideration using the auction algorithm.

### SUMMARY OF THE INVENTION

The present invention provides an apparatus and method for allocating a channel using an auction algorithm in a wireless communication system.

Accordingly, the present invention provides an apparatus and method for allocating a channel using bidding information in a wireless communication system, in which prices (i.e., cost) of the channel are calculated in the terminals, bidding information is transmitted to the base station, and the base station allocates the channel using the bidding information.

Also, the present invention provides an apparatus and method for allocating a channel in a wireless communication system, in which the price of the channel is calculated by comparing performance between the best optimal channel and the next optimal channel.

Also, the present invention provides an apparatus and method for allocating a channel in a wireless communication system in a distributive manner, by which a throughput of the entire system can be increased, and fairness for users can be guaranteed.

According to an aspect of the present invention, there is provided a method of allocating a channel using an auction algorithm in a wireless communication system, the method includes measuring a data rate of each channel; selecting one of the channels, when information on the channels is received from a base station, using the received information on the channels and the measured data rate; and determining a bid of the selected channel.

According to another aspect of the present invention, there is provided a method of allocating a channel using an auction algorithm in a base station, the method includes selecting a terminal when bids for a requested channel are received from one or more terminals, the selected terminal transmitting the highest of the received bids; and allocating the channel requested by the terminal to the selected terminal.

According to another aspect of the present invention, there is provided an apparatus for allocating a channel using an auction algorithm in a mobile communication terminal, the apparatus includes a channel estimation unit for measuring a data rate of each channel; a channel selection unit for selecting a best optimal channel, when prices of the channels are received from a base station, using the measured data rate of each channel and the received prices of the channels, and determining a bid of the selected channel using a difference between a gain of the selected channel and a gain of a next optimal channel; and a bidding price transmission unit for transmitting the determined bid to the base station.

According to a further aspect of the present invention, there is provided an apparatus using an auction algorithm in a base station, the apparatus including a channel allocation unit for allocating a desired channel to a terminal when bids of the desired channel are received from one or more terminals, the desired channel being allocated to the terminal which transmitted the highest bid of the received bids.

### BRIEF DESCRIPTION OF THE DRAWINGS

The above and other features and advantages of the present invention will become more apparent from the following detailed description in conjunction with the accompanying drawings, in which:

FIG. 1 is a block diagram illustrating a base station in a wireless communication system according to the present invention;

FIG. 2 is a flowchart illustrating a channel allocation method of a base station in a wireless communication system according to the present invention;

FIG. 3 is a block diagram illustrating a terminal in a wireless communication system according to the present invention;

FIG. 4 is a flowchart illustrating a channel allocation method of a terminal in a wireless communication system according to the present invention;

FIGS. 5A and 5B are exemplary diagrams illustrating a channel allocation method when the number of channels is greater than the number of users in a wireless communication system according to the present invention;

FIGS. 6A and 6B are exemplary diagrams illustrating a channel allocation method when the number of users is greater than the number of channels in a wireless communication system according to the present invention; and

FIGS. 7A to 7C are exemplary diagrams illustrating a channel allocation method using an auction algorithm in a wireless communication system according to the present invention.

### DETAILED DESCRIPTION OF THE INVENTION

The present invention will now be described more fully with reference to the accompanying drawings, in which exemplary embodiments of the invention are shown. For the sake of clarify, some of the descriptions of relating functions or constructions may be omitted when it is determined that they are well known in the art and unnecessarily obscure the subject matter of the invention.

Hereinafter, an apparatus and method for allocating a channel using an auction algorithm in a wireless communication system according to the present invention will be described.

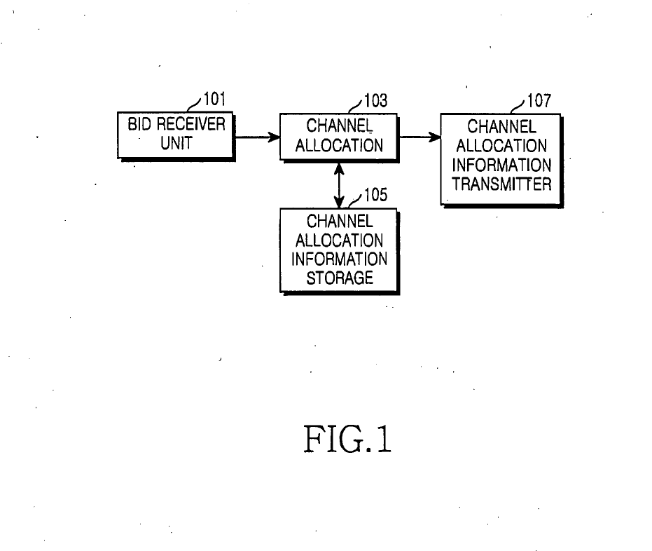

FIG. 1 is a block diagram illustrating components of a base station in a wireless communication system according to the present invention. The base station includes a bidding price receiver unit 101, a channel allocation unit 103, a channel allocation information storage unit 105, and a channel allocation information transmitter unit 107.

Referring to FIG. 1, the bid receiver unit 101 receives bids for a desired channel from each user, and outputs the received bids to the channel allocation unit 103.

The channel allocation unit 103 outputs prices initialized to zero for each channel to the channel allocation information transmitter unit 107, whereby the initialized prices are broadcast to each user. In this case, the initialized price of each channel is stored in the channel allocation information storage unit 105. In addition, the channel is allocated to a user who offers the highest one of the bids input from the bid receiver unit 101 when the channel is desired by a plurality of users. Then, the price of the allocated channel is updated using a previous price of the channel and the highest one of the bids (i.e., bid prices), and the updated price is stored in the channel allocation information storage unit 105. Subsequently, the updated price of the channel is output to the channel allocation information transmitter unit 107 and broadcast to each user.

The channel allocation information storage unit 105 stores the price input from the channel allocation unit 103 for each channel. The channel allocation information transmitter unit 107 transmits the price input from the channel allocation unit 103 for each channel to each user.

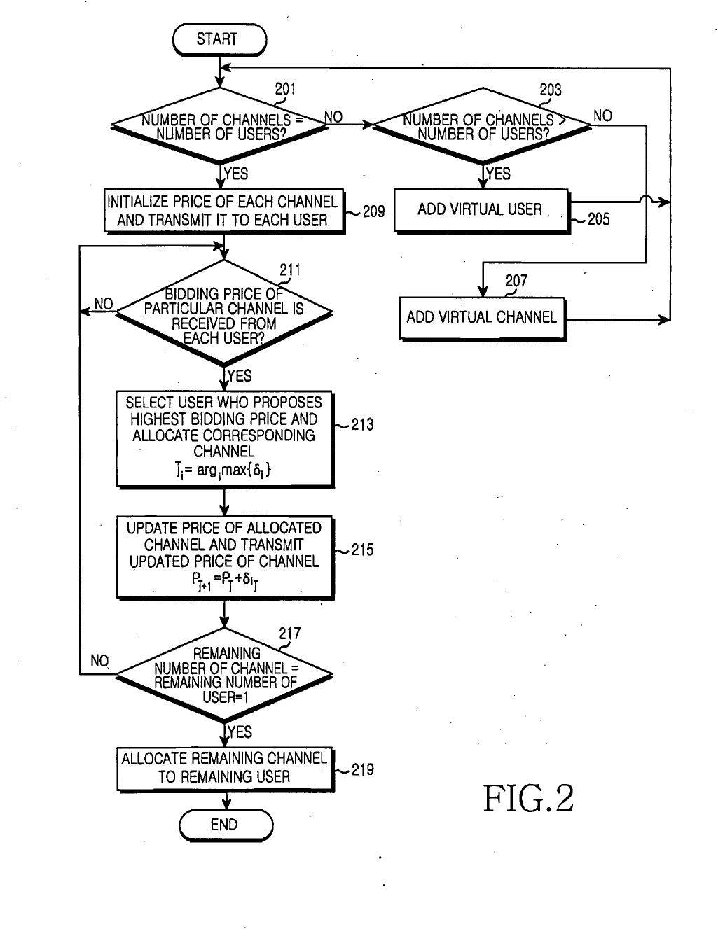

FIG. 2 is a flowchart illustrating a channel allocation process of a base station in a wireless communication system according to the present invention.

Referring to FIG. 2, in a step 201, the base station determines whether the number of the channels to be allocated is equal to the number of users who desire the channels to be allocated.

If it is determined that the number of channels is not equal to the number of the users, the base station determines whether the number of channels is greater than the number of the users in a step 203. If it is determined that the number of channels is greater than the number the users, the base station adds a virtual user in a step 205, and then, the returns to step 201 to determine again whether the number of channels is equal to the number of users who desire the channels to be allocated. On the other hand, in step 203, if it is determined that the number of channels less than the number of the users, the base station adds a virtual channel in a step 207, and then, the process returns to the step 201.

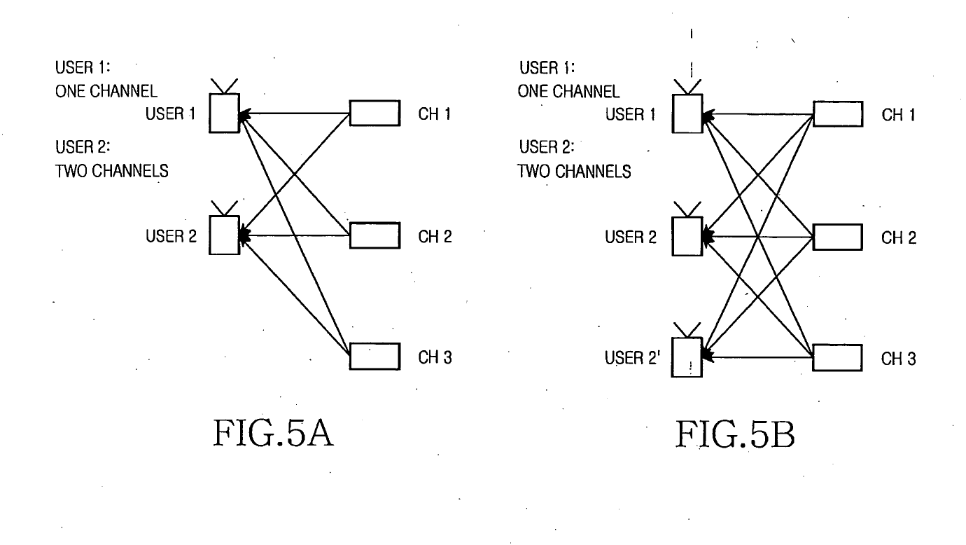

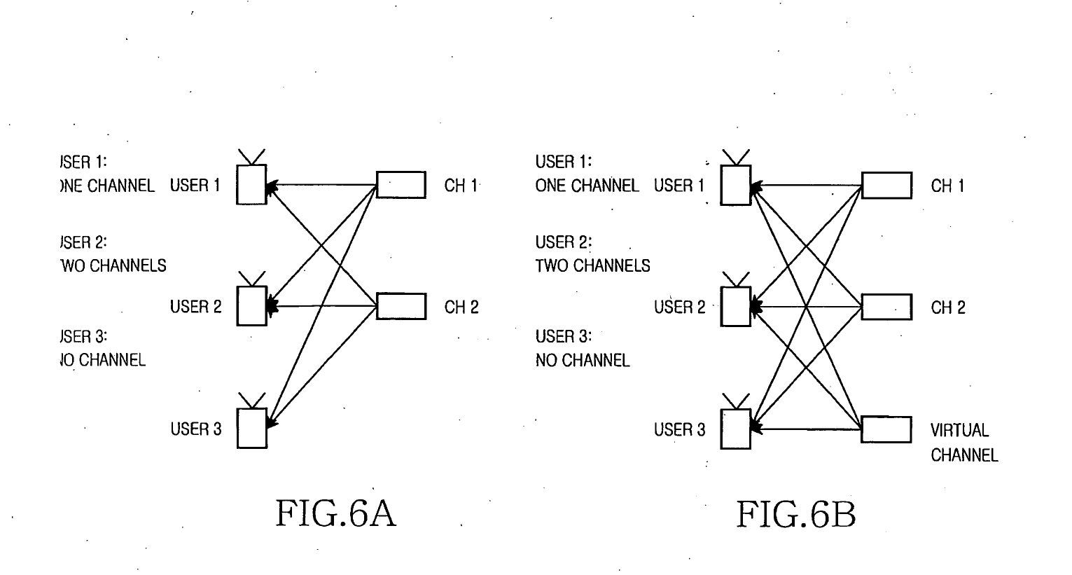

For example, when the number of channels is greater than the number of users, i.e., when a user wants a plurality of channels to be allocated as shown in FIG. 5A, virtual users are added for the user, who wants a plurality of channels to be allocated, as many as the number of channels desired by the user in order to set the number of channels equal to the number of users as shown in FIG. 5B. In addition, when the number of users is greater than the number of channels, i.e., when the number of channels is less than the number of users, as shown in FIG. 6A, a number of virtual channels assumed to have a zero or small gain is added in order to set the number of users to be equal to the number of channels as shown in FIG. 6B.

When it is determined that the number of channels is equal to the number of users, the base station initializes the prices of one or more channels that are to be allocated to one or more users to zero and broadcasts channel information including initialized price of each channel to the users in a step 209.

Subsequently, the base station determines whether the bids of the channels selected by the users are received from the users in a step 211. In this case, the bid is included in a channel bidding upon message together with a user ID, a service type, and a channel ID. Upon determining that the bidding prices for a particular channel are received from each of the users, the process proceeds to a step 213, in which a user who offers the highest one of the received bids is selected, and the channel is allocated to the selected user.

The channel allocated to the user who proposes the highest bid can be expressed as Equation (1):

$${\overline{j}}_{i} = {argmax}_{i} \{ {δ}_{i} \} , \qquad ( 1 )$$

where, i denotes a user index, and δi denotes a bidding prices of an iₜₕ user.

Subsequently, in step 215, the base station updates the price of the channel allocated to the user who offers the highest bid using a price corresponding to the bid. In other words, the price of the channel is updated by adding the initialized price of the channel to the bid. Channel allocation information including the updated price of the channel is transmitted to the users through a channel allocation broadcasting message. In this case, the channel allocation broadcasting message includes information on the channel ID, the user ID allocated to the channel, and the updated information on the price of the channel.

A formula for updating the price of the channel can be expressed as Equation (2):
Pⱼ₊₁=Pⱼ+δᵢ_{ⱼ}, (2)

where, Pⱼ denotes the price of the channel allocated to the user, and δᵢ_{ⱼ} denotes the bidding price proposed by the user who obtains the channel.

Subsequently, in step 217, the base station determines whether both the number of the remaining user and the number of the remaining channel are equal to 1. When it is determined that the number of the remaining users and the number of the remaining channels are not equal to 1, the process returns to the step 211. On the other hand, when it is determined that the number of the remaining users and the number of the remaining channels are equal to 1, the process proceeds to a step 219. In step 219, the base station allocates the remaining channel to the remaining user, and the method according to the present invention is terminated.

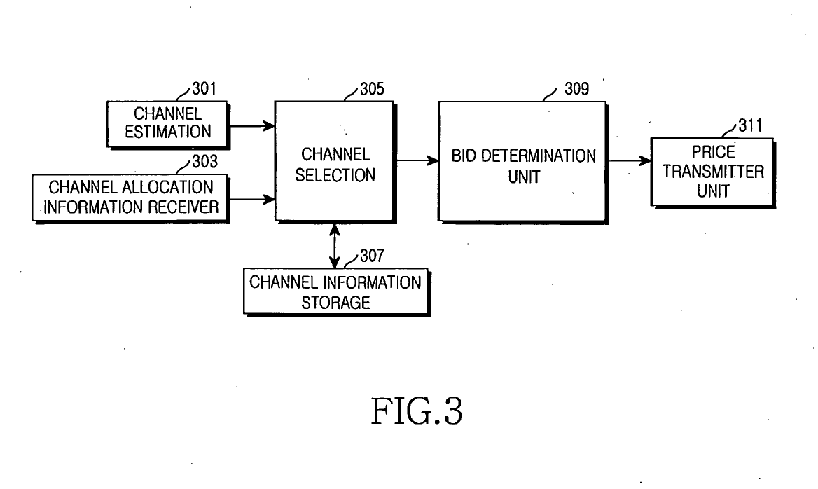

FIG. 3 is a block diagram illustrating a terminal in a wireless communication system according to the present invention. The terminal includes a channel estimation unit 301, a channel allocation information receiver unit 303, a channel selection unit 305, a channel information storage unit 307, a bid determination unit 309, and a price transmitter unit 311.

Referring to FIG. 3, the channel estimation unit 301 measures a data rate of each channel through a periodic channel scanning and outputs the measured data rate of each channel to the channel selection unit 305. In addition, the channel allocation information receiver unit 303 receives the price of each channel from the base station and outputs the received price of each channel to the channel selection unit 305.

The channel selection unit 305 stores the data rate of each channel, input from the channel estimation unit 301 and the price of each channel, input from the channel allocation information receiver unit 303, in the channel information storage unit 307 and updates them, so that the best optimal channel is selected using the updated information. Specifically, a channel having a greatest difference between the data rate and the price of the corresponding channel is selected as the best optimal channel.

The channel information storage unit 307 stores the data rate and the price of each channel.

In addition, the bid determination unit 309 determines the bid of the selected channel and outputs a price corresponding to the determined bid to the price transmitter unit 311 so as to transmit the price (corresponding to the bid) to the base station. In this case, the price corresponding to the bid of the selected channel is determined on the basis of a difference between the gain of the selected channel and the gain of the next optimal channel. The price transmitter unit 311 transmits to the base station the price corresponding to the bid input from the bid determination unit 309 for a particular channel.

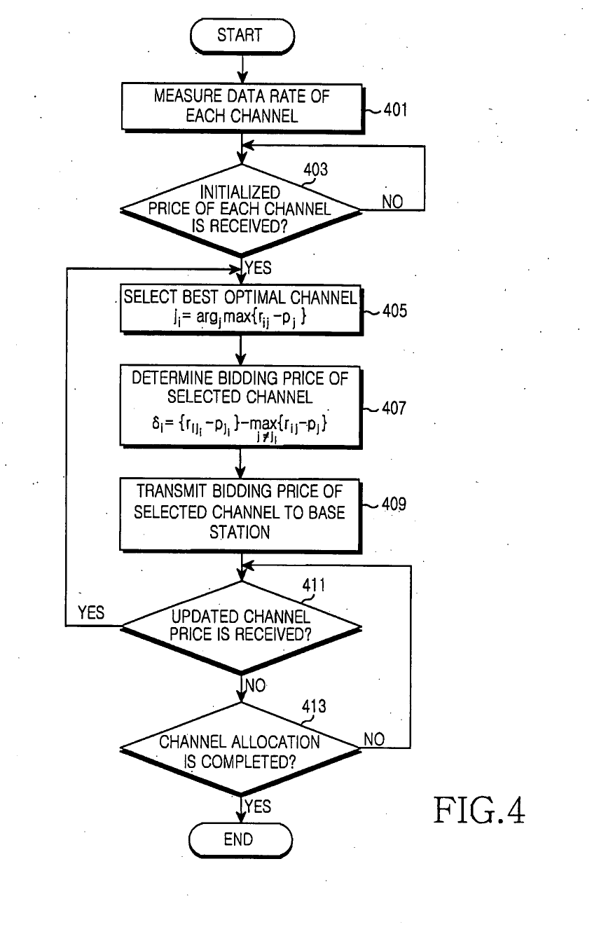

FIG. 4 is a flowchart illustrating a channel allocation process of a terminal in a wireless communication system according to the present invention.

Referring to FIG. 4, the terminal measures a data rate of each channel through a periodic channel scanning in a step 401. There the terminal determines whether channel information including the initialized price of each channel is received from the base station in a step 403. When, in step 403, it is determined that the channel information is received, the terminal selects the best optimal channel using the data rates and the initialized prices of the channels in a step 405. Specifically, a channel having a greatest difference between the data rate and the price of the corresponding channel is selected as the best optimal channel as Equation (3):

$${j}_{i} = {argmax}_{j} \{ {r}_{ij} - {p}_{j} \} , \qquad ( 3 )$$

where, rᵢⱼ denotes a data rate that can be obtained by allocating a channel j to a user i, and pⱼ denotes a price of the channel j.

Subsequently, in step 407, the terminal determines the bid of the selected channel in a step 407. In this case, the bid of the selected channel may be determined by calculating a difference between the gain obtained from the selected channel and the gain obtained from the best optimal one of the remaining channels other than the selected channel. This difference is a loss caused by allocating the next optimal channel instead of the best optimal channel to a user.

The bid of the selected channel can be calculated as Equation (4):

$${δ}_{i} = \{ {r}_{{ij}_{i}} - {P}_{{j}_{i}} \} - {max}_{j \neq {j}_{i}} \{ {r}_{ij} - {p}_{j} \} . \qquad ( 4 )$$

Subsequently, in step 409, the terminal transmits the bid of the determined channel to the base station in a step 409.

In step 411, the terminal determines whether the channel allocation information including the updated price of the channel allocated to a particular user is received from the base station. It should be noted that the bid is included in the channel bid message together with a user ID, a service type, and a channel ID, and the channel bid message is transmitted. When the channel allocation information including the updated price of the allocated channel is determined to be received, the process returns to the step 405. It should be noted that the updated price of the allocated channel is included in the channel allocation broadcasting message together with a channel ID and a user ID who obtains the allocated channel, and the channel allocation broadcasting message is received. When, in step 411, it is determined that the channel information including the updated price of the allocated channel is not received, the process proceeds to a step 413, in which the terminal determines whether the channel allocation is complete. When, in step 413, it is determined that the channel allocation is not complete, the process returns to the step 411. Alternatively, if it is determined that the channel allocation is completed, the terminal terminates the algorithm according to the present invention.

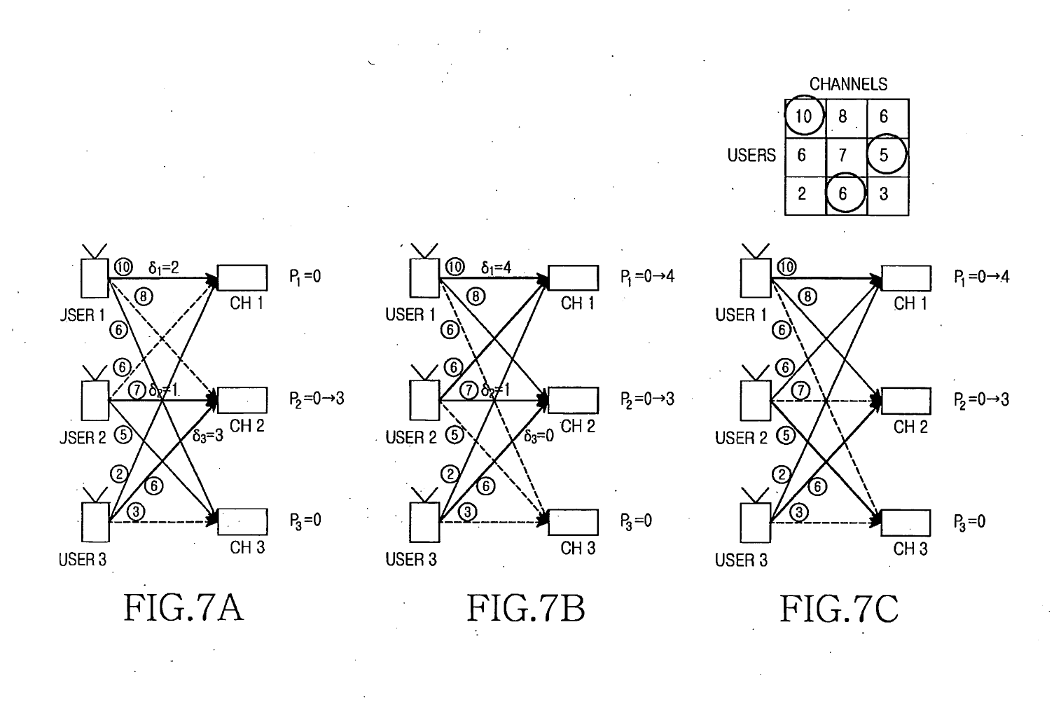

Now, a method of allocating three channels to three users will be described with reference to FIGS. 7A to 7C. In FIG. 7A, the base station initializes the prices of the three channels to zero and transmits data rates and information on the price of each channel to each user. Assuming that, for a user 1, a channel 1 has a data rate of 10 Mbps, a channel 2 has a data rate of 8 Mbps, and a channel 3 has a data rate of 6 Mbps, the user 1 who receives the above information selects the channel 1 because the channel 1 has the greatest difference between the data rate and the price, and transmits the bid (δ1=(10−0)−(8−0)=2) for the channel 1 to the base station. Similarly, assuming that, for a user 2, the channel 1 has a data rate of 6 Mbps, the channel 2 has a data rate of 7 Mbps, and the channel 3 has a data rate of 5 Mbps, the user 2 selects the channel 2 because the channel 2 has the greatest difference between the data rate and the price, and transmits the bid (δ2=(7−0)−(6−0)=1) for the channel 2 to the base station. Similarly, assuming that, for a user 3, the channel 1 has a data rate of 2 Mbps, the channel 2 has a data rate of 6 Mbps, and the channel 3 has a data rate of 5 Mbps, the user 3 selects the channel 2 because the channel 2 has the greatest difference between the data rate and the price, and transmits the bid (δ3=(6−0)−(3−0)=3) for the channel 2 to the base station. In this case, the base station receives the bids of 2, 1, and 3 from the users 1, 2, and 3, respectively, and allocates the channel 2 to the user 3 because the user 3 offers the highest bid. Subsequently, the price of the channel 2 allocated to the user 3 is updated from 0 to 3, and the updated prices of the channels are then transmitted to the users.

Then, as shown in FIG. 7B, the user 1 who received the updated prices of the channels selects the channel 1 because the channel 1 has the greatest difference between the data rate and the price assuming that, for the user 1, the channel 1 has a data rate 10 Mbps and a price of 0, the channel 2 has a data rate of 8 Mbps and a price of 3, and the channel 3 has a data rate of 6 Mbps and a price of 0, and the bid (i.e., price) (δ1=(10−0)−(6−0)=4) of the channel 1 is transmitted to the base station. Similarly, the user 2 selects the channel 1 because the channel 1 has the greatest difference between the data rate and the price assuming that, for the user 2, the channel 1 has a data rate or 6 Mbps and a price of 0, the channel 2 has a data rate of 7 Mbps and a price of 3, and the channel 3 has a data rate of 5 Mbps and a price of 0, and the bid (δ2=(6−0)−(5−0)=1) of the channel 1 is transmitted to the base station. Similarly, the user 3 selects the channel 2 because the channel 2 has the greatest difference between the data rate and the price assuming that, for the user 3, the channel 1 has a data rate of 2 Mbps and a price of 0, the channel 2 has a data rate of 6 Mbps and a price of 3, and the channel 3 has a data rate of 3 Mbps and a price of 0, and the bid (δ3=(6−3)−(3−0)=0) of the channel 2 is transmitted to the base station. In this case, the base station receives the bids of 4, 1, and 0 from the users 1, 2, and 3, respectively, and allocates the channel 1 to the user 1 who offers the highest bid. Then, the price of the channel 1 allocated to the user 1 is updated from 0 to 4, and the updated price of the channel is transmitted to the users.

Subsequently, as shown in FIG. 7C, the base station allocates the remaining channel 3 to the remaining user 2. As a result, the channel 1 having a data rate of 10 Mbps is allocated to the user 1, the channel 2 having a data rate of 6 Mbps is allocated to the user 3, and the channel 3 having a data rate of 5 Mbps is allocated to the user 2, so that throughput is maximized.

As described above, according to the present invention, the terminals in a wireless communication system calculate prices of the channels and transmit bidding information to the base station, so that the base station allocates the channels based on the bidding information. Consequently, it is possible to improve performance of the entire system by reducing complexity as well as guaranteeing an optimal value.

While the present invention has been particularly shown and described with reference to exemplary embodiments thereof, it will be understood by those skilled in the art that various changes in form and details may be made therein without departing from the spirit and scope of the present invention, as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of allocating one or more channels using an auction algorithm in a wireless communication system, the method comprising the steps of:
measuring a data rate of each channel;
selecting one of the channels using information corresponding to the channels received from a base station and the measured data rate of each channel; and
determining a bid of the selected channel.

2. The method of claim 1, wherein the information corresponding to the channels includes prices of the channels.

3. The method of claim 2, wherein selecting one of the channels comprises:
calculating a difference between the measured data rate and price of each of the channels; and
selecting a channel having the greatest difference.

4. The method of claim 3, wherein determining the bid of the selected channel comprises:
selecting a channel having a second largest difference among channels; and
calculating a difference between the largest difference and the second largest difference.

5. The method of claim 1, further comprising:
transmitting the determined bid to the base station;
selecting one of the channels using received updated information on the channels from the base station and the measured data rate;
determining a bid of the selected channel; and
transmitting the determined bid to the base station.

6. A method of allocating a channel using an auction algorithm in a base station, the method comprising the steps of:
selecting a terminal of a plurality of terminals having transmitted the highest bidding prices for a requested channel of a plurality of channels; and
allocating the requested channel to the selected terminal.

7. The method of claim 6, further comprising transmitting information on one or more allocatable channels to the terminals.

8. The method of claim 7, wherein the information on the channels includes a price of each channel.

9. The method of claim 8, further comprising initializing the price of each channel.

10. The method of claim 6, further comprising:
determining whether the number of the channels is equal to the number of the terminals;
adding a virtual channel when it is determined that the number of the terminals is greater than the number of the channels; and
adding a virtual terminal when it is determined that the number of the terminals is less than the number of the channels.

11. The method of claim 6, further comprising updating a price of the allocated channel and transmitting the updated price of the channel to the terminals.

12. The method of claim 11, wherein the price of the channel is updated using a sum of the previous price of the channel and the bid.

13. A mobile communication terminal for allocating a channel using an auction algorithm comprising:
a channel estimation unit for measuring a data rate of each channel of a plurality of channels;
a channel selection unit for selecting a channel using the measured data rate of each channel and information corresponding to the channels from a base station; and
a bid determination unit for determining a price of a selected channel using a difference between a gain of the selected channel and a gain of a next optimal channel.

14. The mobile communication terminal of claim 13 further comprising a price transmission unit for transmitting a price corresponding to the determined bid to the base station.

15. The mobile communication terminal of claim 13, wherein the channel selection unit selects a channel having a greatest difference between the measured data rate of a channel and the price of the corresponding channel.

16. The mobile communication terminal of claim 13, wherein the information corresponding the channels includes prices of the channels.

17. A base station for allocating a channel using an auction algorithm comprising a channel allocation unit allocating a channel to a mobile communication terminal having transmitted the highest bid among mobile communication terminals,

18. The base station of claim 17, wherein the channel allocation unit updates a price of the channel using a sum of the previous price of the channel and the bid, and outputs a channel allocation message including the updated price of the channel, and
wherein the apparatus further comprises a channel allocation information transmission unit for transmitting the channel allocation message to the terminals.

19. The base station of claim 17, wherein the channel allocation unit transmits information corresponding to one or more allocatable channels to the mobile communication terminals.

20. The base station of claim 19, wherein the information corresponding to the channels includes a price of each channel.
